(19) United States
(12) Patent Application Publication
(10) Pub. No.: US 2015/0199570 A1
(43) Pub. Date: Jul. 16, 2015

(54) INTERACTIVE OBJECT AND TRACK ARRAY BASED IMAGE ANALYSIS METHOD

(71) Applicant: DRVision Technologies LLC

(72) Inventor: Shih-Jong James Lee, Bellevue, WA (US)

(73) Assignee: DRVision Technologies LLC

(21) Appl. No.: 14/156,436

(22) Filed: Jan. 15, 2014

(51) Int. Cl. G06K 9/00; G06T 7/00; G06T 11/60; G06K 9/46

(52) U.S. Cl. CPC G06K 9/00624; G06K 9/4604; G06T 7/0079; G06T 11/60; G06T 2207/20104

(57) ABSTRACT

A computerized interactive image analysis method that generates a displayed object region, track region or object sequence array to enable efficient interactive analysis to verify, edit and create a subpopulation of objects, tracks or object region sequences. It enables statistical test applying to a single or a plurality of subpopulation data acquired from a single or a plurality of input images and a single or a plurality of interactive analysis steps.

### STATEMENT AS TO RIGHTS TO INVENTIONS MADE UNDER FEDERALLY SPONSORED RESEARCH AND DEVELOPMENT

This work was supported by U.S. Government grant number 5R44HL106863-03, awarded by the National Heart, Lung, and Blood Institutes. The U.S. Government may have certain rights in the invention.

### BACKGROUND OF THE INVENTION

1. Field of the Invention

The present invention relates to computerized image analysis and more particularly to interactive object and track array based image analysis methods.

2. Description of the Related Art

a. Description of Problem that Motivated the Invention

Computerized image analysis, namely, computer extraction of regions containing objects of interest such as semiconductor wafer defects, circuit boards, bond wires, ball grid array, pad grid array, electronic package, tissues, cellular and subcellular components, bacteria, viruses and analysis of the features measured from the regions, is a fundamental step in electronic industry quality control and quantitative microscopy which have broad applications and markets.

Due to the complexity of the image analysis tasks, it is difficult to have fully automated solutions except some dedicated high-volume applications such as cancer screening, wafer defect inspection. Most of the computerized image analysis applications require interactive confirmation, editing and data analysis by users.

b. How Did Prior Art Solve the Problem?

Currently, most users perform image analysis using standard image processing software (such as Zeiss' AxioVision, Nikon's NIS-Elements, Olympus cellSens, ImageJ, Metamorph, ImagePro, Slidebook, Imaris, Volocity, etc.), custom scripts/programming, or by hand. It is difficult to apply standard image processing software functions to perform image analysis. As a result the majority of image analysis is performed either manually or using a simple method that has very limited applications and poor results. Biology image analysis products have been developed recently for high content screening applications. However, they are coupled to specific instrument platforms, cell types, and reagents. They are not flexible for broad applications.

The advancement in image acquisition and storage technologies enables many large volume image analysis applications. For example, applications including multi-spectral, 3D and time-lapse image sequences are becoming common. The interactive process in the large volume analysis applications are challenging as the large size of images, objects and data make it inefficient to perform interactive image analysis.

There are some prior art work such as making montage using imageJ that allows multi-cropping of images and assembles them into an image montage or showing photo galleries. However, the prior art work are limited to showing a lot of information in a small amount of space. It does not support efficient interactive image analysis including data confirmation, editing, measurements and subpopulation creation.

### BRIEF SUMMARY OF THE INVENTION

The current invention includes a computerized object region array interactive image analysis method that generates a displayed object region array to enable efficient interactive object region analysis to verify, edit and create a subpopulation of objects. It enables statistical test applying to a single or a plurality of subpopulation data acquired from a single or a plurality of input images and a single or a plurality of interactive object region analyses. The method is especially efficient for time-lapse image sequences as the displayed track or image sequence array allows a frame view for easy viewing and the focused track or image sequence can be navigated to view tracked object or image sequence at different time frames.

The primary objective of the invention is to provide an object region array for computerized interactive object analysis. The secondary objective of the invention is to provide a track region array for computerized interactive track analysis. The third objective of the invention is to provide an object region sequence array for computerized interactive object sequence analysis.

### Application Scenarios

There are three application scenarios of the current invention: a computerized object region array interactive object analysis, a computerized track array interactive track analysis, and a computerized object sequence array interactive object sequence analysis.

FIG. 1 shows the processing flow of the computerized object region array interactive object analysis method. An input image 100 is loaded into a computer memory for object detection 102 performed by a computer program. The object detection 102 step processes the input image 100 to generate a plurality of detected objects 104. The detected objects 104 are processed by an object selection 106 step to generate a plurality of selected objects 108. The selected objects 108 are shown in a computer display by an object array display 110 step to generate a displayed object region array 112. Finally, an interactive object region analysis 114 step is performed using the input image 100, the selected objects 108 and the displayed object region array 112 to generate an object analysis outcome 116.

FIG. 2 shows the processing flow of the computerized track array interactive track analysis method. An input image sequence 200 is loaded into a computer memory for object tracking 202 performed by a computer program. The object tracking 202 step processes the input image sequence 200 to generate a plurality of detected tracks 204. The detected tracks 204 are processed by a track selection 206 step to generate a plurality of selected tracks 208. The selected tracks 108 are shown in a computer display by a track array display 210 step to generate a displayed track array 212. Finally, an interactive track analysis 214 step is performed using the input image sequence 200, the selected tracks 208 and the displayed track array 212 to generate a track analysis outcome 216.

FIG. 3 shows the processing flow of the computerized object sequence array interactive object sequence analysis method. An input image sequence 200 is loaded into a computer memory for object detection 102 performed by a computer program. The object detection 102 step processes on one frame of the input image sequence 200 to generate a plurality of detected objects 104 wherein the one frame of the input image sequence 200 can be specified by a user. The default frame is the first frame of the input image sequence 200. The detected objects 104 are processed by an object selection 106 step to generate a plurality of selected objects 108. The selected objects 108 are shown in a computer display by an object sequence array display 310 step to generate a displayed object region sequence array 312. Finally, an interactive object sequence analysis 314 step is performed using the input image sequence 200, the selected objects 108 and the displayed object region sequence array 312 to generate an object sequence analysis outcome 316.

### BRIEF DESCRIPTION OF THE DRAWINGS

FIG. 1 shows the processing flow of the computerized object region array interactive object analysis method.

FIG. 2 shows the processing flow of the computerized track array interactive track analysis method.

FIG. 3 shows the processing flow of the computerized object sequence array interactive object sequence analysis method.

FIG. 4 shows the processing flow of the object detection method.

FIG. 5 shows the processing flow of the object detection method with interactive update.

FIG. 6 shows the processing flow of the object selection step.

FIG. 7 shows an embodiment of whole image display, object data graph and object data sheet.

FIG. 8 shows an embodiment of the displayed object region array.

FIG. 9 shows an embodiment of the displayed object region array along with whole image display, object data graph, and object data sheet.

FIG. 10 shows the processing flow of the object tracking method.

FIG. 11 shows the processing flow of the object detection method with interactive track update.

FIG. 12 shows the processing flow of the track selection step.

FIG. 13 shows an embodiment of whole image display for a detected track.

FIG. 14 shows an embodiment of displayed track array with focuses track and frame view.

### DETAILED DESCRIPTION OF THE INVENTION

The present invention is described below for the three above-mentioned application scenarios.

### I. Computerized Object Region Array Interactive Object Analysis

### I.1 Input Image

The input image 100 can be acquired from any digitization methods such as camera, scanner, photomultipliers, image sensors, etc. The images can be acquired with different spectral and modalities such as bright field, dark field, X-ray, IR, ultrasound, lasers, etc. in multi-dimensional (X, Y, Z, spectral, position) spaces.

In one embodiment of the invention, microscopy images are used as the input images. The microscopy images can be acquired from different microscopy modes such as Total internal reflection fluorescence microscopy (TIRF), bright-field, Phase contrast, Differential interference contrast (DIC) microscopy, FRAP, FLIM and FRET and also may be from 2D and 3D microscopy such as inverted, confocal and super-resolution microscopes.

### I.2 Object Detection

As shown in FIG. 4, the object detection 102 inputs the input image 100 and performs object segmentation 400. The object segmentation 400 step processes the input image 100 and generates a plurality of segmented objects 402. The segmented objects 402 consist of a plurality of object masks. The segmented objects 402 are processed by an object measurement 404 step to label each object with a unique ID and to generate characterization features for each segmented object. The segmented objects 402 and their characterization features together form the detected objects 104.

### A. Object Segmentation

In one embodiment of the invention, a structure guided processing method as described in Lee; Shih-Jong J. “Structure-guided image processing and image feature enhancement”, U.S. Pat. No. 6,463,175, Sep. 24, 2002 and Lee; Shih-Jong J., Oh; Seho, Huang; Chi-Chou,“Structure-guided automatic learning for image feature enhancement” U.S. Pat. No. 6,507,675, Jan. 14, 2003 can be used for object segmentation.

In another embodiment of the invention, the teachable segmentation method as described in Lee; Shih-Jong J., Oh; Seho “Learnable Object Segmentation”, U.S. Pat. No. 7,203,360, Apr. 10, 2007 can be used for object segmentation.

In alternative embodiments of the invention, segmentation methods such as thresholding, watershed, modeling, clustering methods can also be used for the object segmentation.

### B. Object Measurements

The object measurements generate characterization features for each segmented object. A comprehensive set of characterization features can be is extracted from a single or a plurality of segmented objects. In one embodiment of the invention, the characterization features include intensity space features, color space features and relational features.

### B.1 Intensity Space Features

The features are derived from the grayscale intensity in the region of a segmented object such as mean, standard deviation, skewness, kurtosis and other statistics. Moreover, pre-processing of the grayscale intensity can be performed before extracting the statistics. The pre-processing includes point operations such as logarithm conversion for optical density measurement or filtering such as edge enhancement by linear or morphological gradient operator that includes dark edge, bright edge, general edge enhancement, line enhancement, corner enhancement, etc.

Note that when there are multiple channel images derived from different markers and/or imaging modalities, the intensity space features from each of the different channels can all be included.

In alternative embodiments of the invention, other intensity space features such as texture features derived from co-occurrence matrices or wavelet, run-lengths etc. may be used.

### B.2 Color Space Features

When the input image is a color image, color transformation may be applied to convert the color image into multi-bands of grayscale images. In one embodiment of the invention, the multiple bands include the following images: R (Red channel), G (Green channel), B (Blue channel), (R−G)/(R+G), R/(R+G+B), G/(R+G+B), B/(R+G+B), R/G, R/B, G/B, G/R, B/G, B/R, etc. In addition, RGB to HSI conversion can be performed to generate hue, saturation, and intensity bands.

The intensity space features with and without pre-processing as described in section B.1 can be generated for each band of the image.

In alternative embodiments of the invention, other feature spaces such as temporal space (for image sequences) or different focal planes (for 3D images) may be used.

### B.3 Relational Features

Relational features can characterizes spatial relations of multiple sets of objects by comprehensive collections of spatial mapping features. Some of the features have clearly understandable physical, structural, or geometrical meanings. Others are statistical characterizations, which may not have clear physical, structural or geometrical meanings when considered individually. A combination of these features could characterize subtle difference numerically using the comprehensive feature set.

In one embodiment of the invention, the relational feature extraction method as described in Lee; Shih-Jong J., Oh; Seho “Intelligent Spatial Reasoning”, U.S. Pat. No. 7,263,509, Aug. 28, 2007 can be used for relational features.

### B.4 Summary Features

The whole image summary features for all segmented objects such as cells, colonies or grids from the image can be generated. The summary features include summary statistics such as mean, variance, skewness, kurtosis, median, and top and bottom percentiles of the pattern features from the segmented objects of the image.

The object segmentation step may be assisted by an interactive update step. As shown in FIG. 5, the object segmentation step outputs preliminarily segmented objects 500. The preliminarily segmented objects 500 are further processed by the interactive update 502 step to generate the segmented objects 402 for object measurement 404 to generate detected objects 104.

The interactive update step shows the preliminarily segmented objects 500 to a user. The user can update the segmentation masks of the preliminarily segmented objects 500 by drawing new masks, deleting or inserting masks or using magic wand and/or other touch up tools such as the tools provided in Adobe photoshop software. After the interactive update, the resulting segmented objects should have user satisfied segmentation masks.

### 1.3. Object Selection

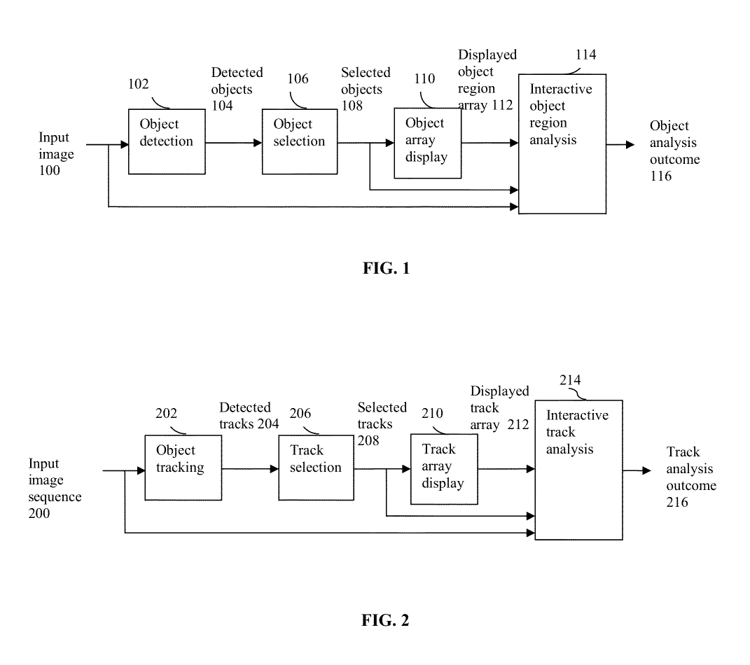

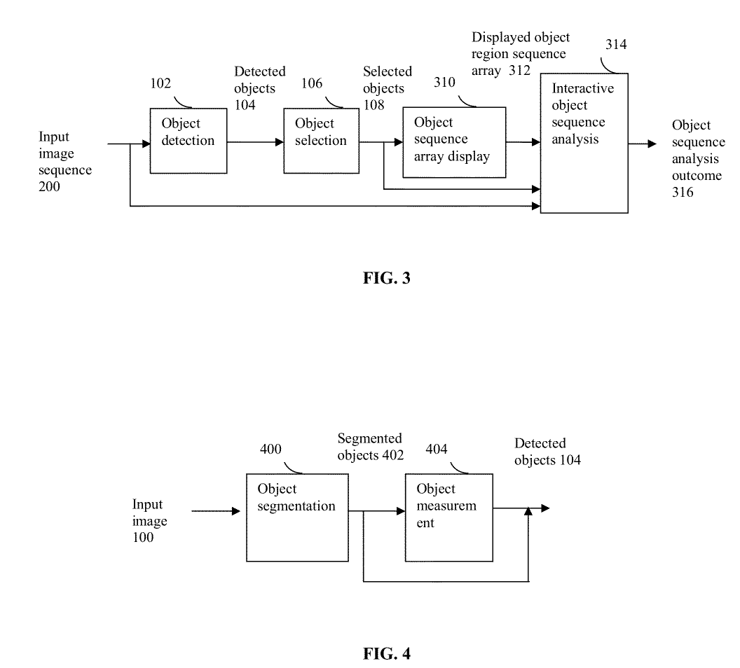

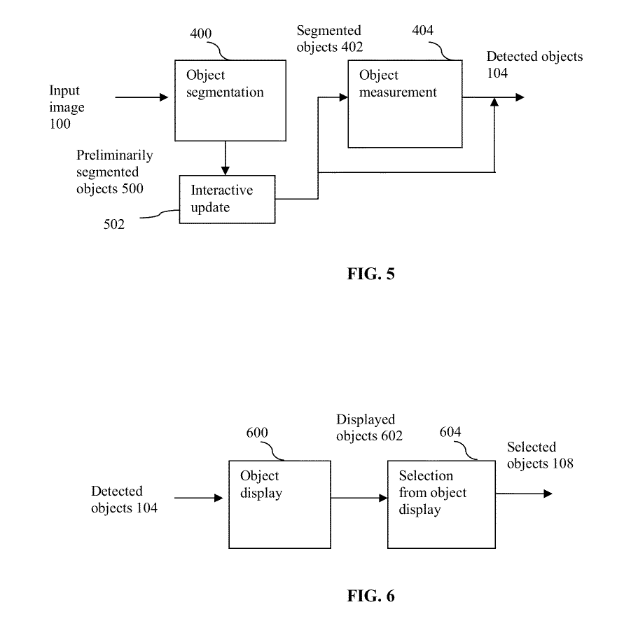

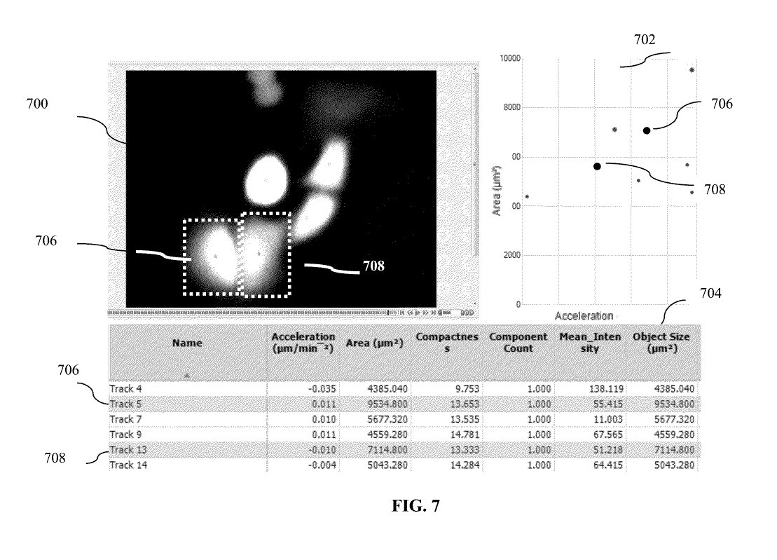

As shown in FIG. 1, the detected objects 104 are processed by an object selection 106 step to generate a plurality of selected objects 108. The object selection further comprises the steps as shown in FIG. 6. In FIG. 6, the detected objects are processed by an object display 600 step to generate displayed objects 602 that are shown in a computer display. The displayed objects 602 are viewed by a user to perform selection from object display 604 step. This results in the selected objects 108.

The displayed objects display the detected objects on the computer display under a display mode selected from a group consisting of a whole image display, at least one object data graph, and at least one object data sheet. The whole image display highlights the detected objects with object indicators such object center, object bounding box, or other indication such as object masks with different colors for different objects. The object data graph is selected from a group consisting of a feature histogram plot, an object histogram plot, a scatter plot and a stacked scatter plot, radial graph, mesh graph, surface graph, volumetric graph, etc. The object data sheet contains sheets for object features and summary features.

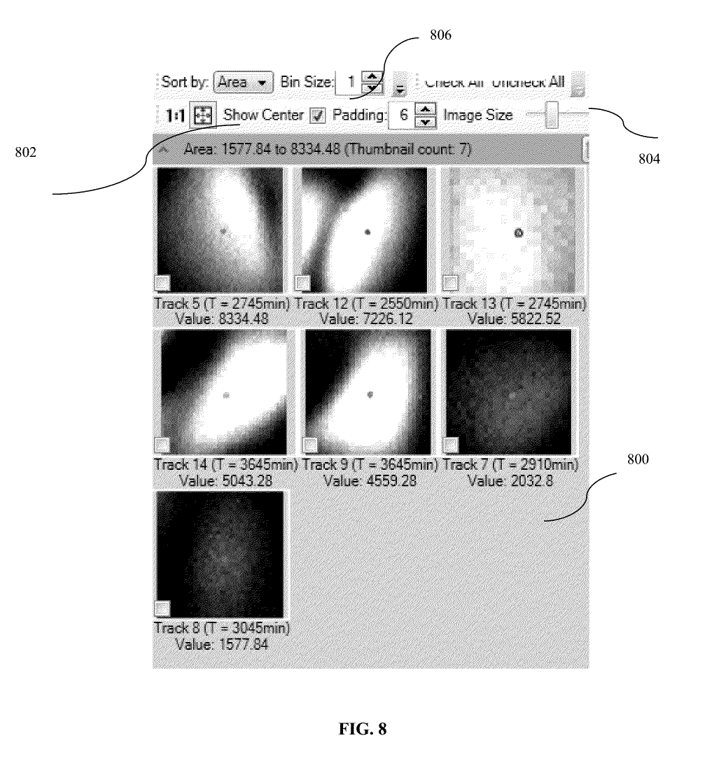

FIG. 7 shows an embodiment of whole image display 700, object data graph 702 wherein the data graph is a scatter plot, and object data sheet 704 which contains object feature. In one embodiment of the invention, the whole image display 700, the at least one object data graph 702, and the at least one object data sheet 704 are linked wherein selecting objects in one display mode also selects the objects in other modes. Note that the selected objects 706 and 708 can be seen in all three display modes.

### 1.4. Object Array Display

The object array display 110 step shows the selected objects 108 in a computer display. It is shown as a displayed object region array 112. In the displayed object region array, the selected object regions are cut out and shown as an array (1D or 2D) of object regions in the computer display. FIG. 8 shows an embodiment of the displayed object region array 800 with 7 objects selected and arranged in a 2D 3 by 3 format. The displayed object region array displays regions of the selected objects sorted under an order selected from a group consisting of object feature ranking, object indices, and manual arrangement.

The displayed object region array 800 consists of an option 802 to indicate an object location within its object region such as a circle in the center of the object or arrows, boxes, etc. It also consists of an option to overlay an object with its segmentation mask and an option to show multi-channel composite color view of an object if the image includes multiple acquisition channels.

Other options include image zoom 804, padding of image region boundary 806.

### I.5. Interactive Object Region Analysis

An interactive object region analysis 114 step is performed using the input image 100, the selected objects 108 and the displayed object region array 112 to generate an object analysis outcome 116.

The displayed object region array can be shown along with other display modes such as the whole image display 700, the at least one object data graph 702, and the at least one object data sheet 704. The data from different display modes 800, 700, 702, 704 are linked.

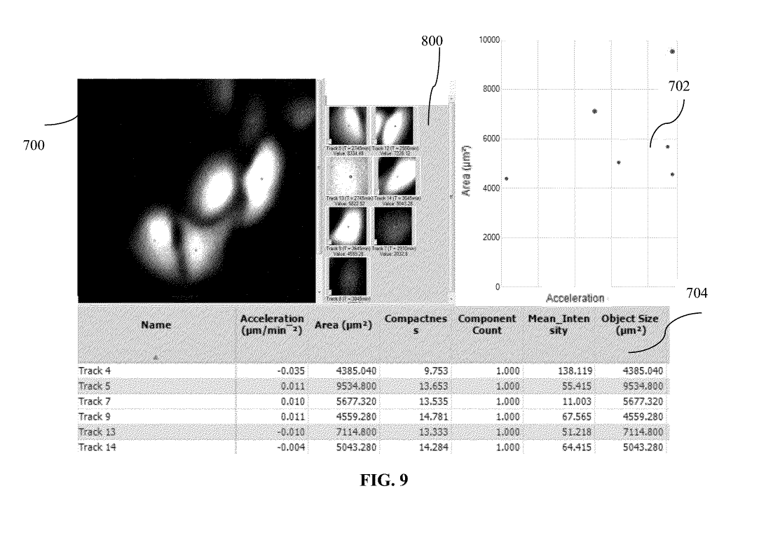

The interactive object region analysis picks a focused object from any of the display modes and the object is focused (highlighted) in other display modes. FIG. 9 shows an embodiment of the displayed object region array 800 along with whole image display 700, object data graph 702, and object data sheet 704.

The interactive object region analysis views the input image, the selected objects and the displayed object region array in different display modes and performs a single or a plurality of analysis steps including

a) deleting an object from the displayed object region array
If the purpose of the analysis is to create a subpopulation of objects, the unwanted objects can be deleted.
   b) assigning a label to an object in the displayed object region array
If the purpose of the analysis is to categorize objects, the objects can be labeled for each category.
   c) entering annotation to an object in the displayed object region array
If the purpose of the analysis is to comment on the objects, the objects can be annotated.
   d) editing an object mask and updating object measurements
If the purpose of the analysis is to confirm object detection results, the object segmentation mask can be edited to yield accurate object analysis outcome
   e) performing manual measurements of an object
If the purpose of the analysis is to flexibly characterize the selected objects, manual measurements can be performed. In one embodiment of the invention, the measurement types include (i) line: distance between two end points; (ii) region: area and other characterization features of the region such as mean and standard deviation of region intensity distribution; (iii) angle: angle between two lines. User can draw line, region or angle and the computer will automatically calculate the features from the manual drawing.
   f) creating a subpopulation of objects
A subpopulation of objects with the appropriate categorization and measurements can be created as the analysis outcome.

The object analysis outcome 116 could be the outcomes of any of the above analysis steps or their combinations. In one embodiment of the invention, the object analysis outcome 116 is a subpopulation of objects after deleting unwanted objects and properly label the desired objects.

In one embodiment of the invention, the outcomes of any of the above analysis steps or their combinations such as a subpopulation of objects with correct masks and/or desired measurements can be further analyzed using at the least one object data graph 702, and the at least one object data sheet 704. Furthermore, the data could be tested using statistical test methods such as T-test, ANOVA test, MANOVA test, Wilcoxon-Mann Whitney test, Chi-square test, Mcnemar's test, Fisher's test, binomial test, Kolmogorov-Smirnov test, etc.

In another embodiment of the invention, a plurality of subpopulation data acquired from a plurality of input images and a plurality of interactive object region analyses can be combined and further analyzed using object data graph or object data sheet. Furthermore, the combined data could be tested using statistical test methods such as T-test, ANOVA test, MANOVA test, Wilcoxon-Mann Whitney test, Chi-square test, Mcnemar's test, Fisher's test, binomial test, Kolmogorov-Smirnov test, etc.

### II. Computerized Track Array Interactive Track Analysis

### II.1 Input Image Sequence

The input image sequence 200 can be acquired from the same methods as input image 100 described in section I.1 except that the input image sequence 200 includes temporal dimension. That is, it contains a time sequence of input image 100.

### II.2 Object Tracking

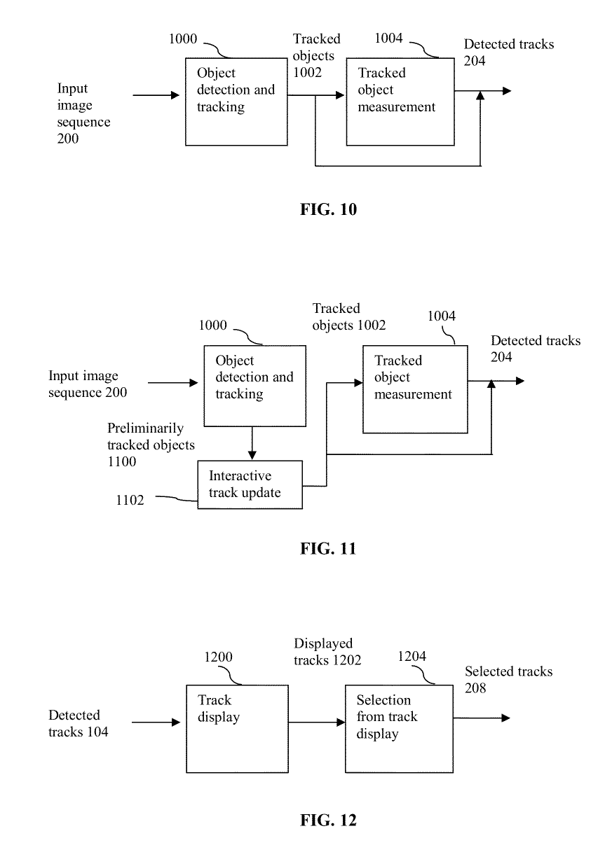

As shown in FIG. 10, the object tracking 202 inputs the input image sequence 200 and performs object detection and tracking 1000. The object detect and track 1000 step processes the input image sequence 200 and generates a plurality of tracked objects 1002. The tracked objects 1002 consist of a plurality of object masks and/or positions over different time points. The tracked objects 1002 are processed by a tracked object measurement 1004 step to generate characterization features for each track and for the object of the track at each time point. That is, the characterization features include time dependent object features and time independent track features. The tracked objects 1002 and their characterization features together form the detected tracks 204.

### A. Object Detection and Tracking

In one embodiment of the invention, the object detect and track includes object segmentation followed by the tracking of the segmented objects. This embodiment is suitable for the tracking of large objects such as cells or colonies. In this embodiment, the object segmentation can be performed using the method as described in section I.2.A.

In another embodiment, the objects are detected and tracked directly without segmentation. This embodiment is suitable for the tracking of small objects such as particles. For object tracking, the method described in Lee; Shih-Jong J., Oh; Seho “Method for moving cell detection from temporal image sequence model estimation”, U.S. Pat. No. 8,045,783, Oct. 25, 2011 can be used. In alternative embodiments of the invention, other tracking methods such as autocorrelation, Kalman filter, etc. can also be used for tracking.

### B. Tracked Object Measurements

The tracked object measurement 1004 step generates characterization features for each track and for the object of the track at each time point. That is, the characterization features include time dependent object features and time independent track features.

The time dependent object features include the characterization features described in section II.2.B for each time point. In addition, kinetic features such as the changes in intensity space, color space and relational features as well as the change velocity, change acceleration of the trajectories and their pattern features can be included.

The time independent track features include whole track trajectory features such as Total time, First Frame, Last Frame, Sum of incremental velocity in x and y directions over the whole track, Sum of square of incremental velocity in x and y directions over the whole track, Length of the straight line connecting track starting and end points, Straight line length divided by Total Time, Total incremental distances of curvature track path, Total Length divided by Total Time, Sum of angle change within the length of the track, Ratio of Straight Line Velocity to Curvilinear Velocity, The area of a bounding box generated from the minimum and maximum values of x- and y-coordinates over track lifetime, etc.

The object detection and tracking step may be assisted by an interactive track update step. As shown in FIG. 11, the object detection and tracking step outputs preliminarily tracked objects 1100. The preliminarily tracked objects 1100 are further processed by the interactive track update 1102 step to generate the tracked objects 1002 for tracked object measurement 1004 to generate detected tracks 204.

The interactive track update 1102 step shows the preliminarily tracked objects 1100 to a user. The user can update the segmentation masks and or the tracks of the preliminarily tracked objects 1100 by editing masks and/or deleting, connect, insert tracks. After the interactive track update, the resulting tracked objects should have user satisfied tracks and/or segmentation masks.

### II.3. Track Selection

As shown in FIG. 2, the detected tracks 204 are processed by a track selection 206 step to generate a plurality of selected tracks 208. The track selection further comprises the steps as shown in FIG. 12. In FIG. 12, the detected tracks are processed by a track display 1200 step to generate displayed tracks 1202 that are shown in a computer display. The displayed tracks 1202 are viewed by a user to perform selection from track display 1204 step. This results in the selected objects 208.

The displayed tracks display the detected tracks on the computer display under a display mode selected from a group consisting of a whole image display, at least one data graph, and at least one data sheet. The whole image display highlights the detected tracks with track indicators. The indicator could include a trajectory plot of time course of the tracked object center with time span specifiable. The trajectory could be colored or faded as a function of time. The trajectory colors could be different for different tracks. The data graph is selected from a group consisting of a feature histogram plot, an object histogram plot, a scatter plot, a stacked scatter plot, radial graph, mesh graph, surface graph, volumetric graph, a time trace plot, a directional plot, a linage plot, a kymograph, or a mean-squared displacement time plot, etc. The data sheet is selected from a group consisting of sheet of summary statistics, sheet of object measurements per time point, sheet of track measurements, and sheet of lineage measurements.

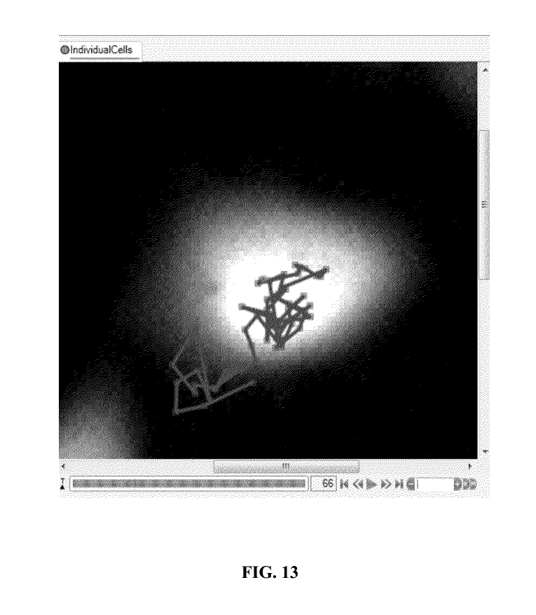

FIG. 13 shows an embodiment of whole image display 1300 for a detected track showing a tracked object and its trajectory. In one embodiment of the invention, the whole image display 1300, the at least one data graph, and the at least one data sheet are linked wherein selecting tracks in one display mode also selects the tracks in other modes. The selected tracks can be seen in all display modes.

### II.4. Track Array Display

The track array display 210 step shows the selected tracks 208 in a computer display. Similar to the object array display described in section II.4, it is shown as a displayed track array 212. In the displayed track array, the selected tracks at each time point are cut out and shown as an array (1D or 2D) of track regions in the computer display. The displayed track array displays regions of the selected tracks sorted under an order selected from a group consisting of track feature ranking, track indices, and manual arrangement.

The displayed track array displays regions of the selected tracks at a time frame selected from a group consisting of track middle frame, track first frame, track last frame, and track event frame. The displayed track array consists of an option to indicate a tracked object location within its track array region such as a circle in the center of the tracked object or arrows, boxes, etc. It also consists of an option to overlay a tracked object with its segmentation mask and an option to show multi-channel composite color view of a tracked object if the image includes multiple acquisition channels. Other options include image zoom, padding of image region boundary, etc.

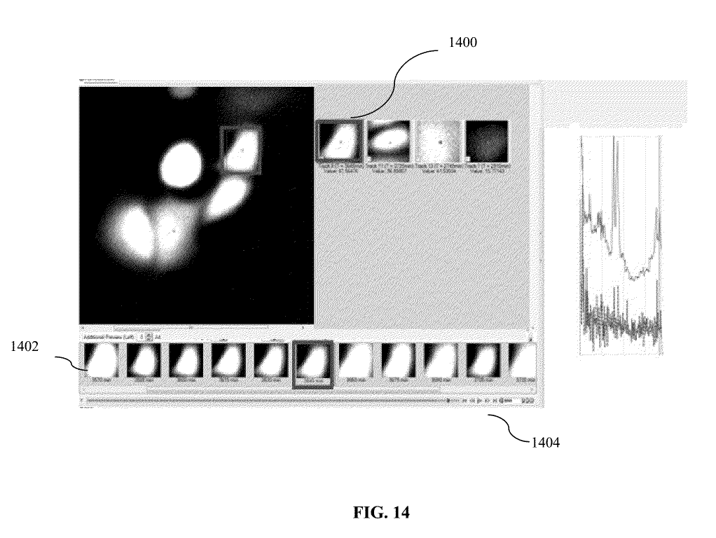

As shown in FIG. 14, in one embodiment of the invention, the displayed track array allows the pick of a focused track 1400. The focused track is highlighted in the displayed track array. In addition, a frame view 1402 corresponds to the focused track can be optionally displayed. The frame view 1402 displays the consecutive frames of the focused track. The focused track and its frame view can be navigated to view tracks at different time frames using a navigation bar 1404.

### II.5. Interactive Track Analysis

An interactive track analysis 214 step is performed using the input image sequence 200, the selected tracks 208 and the displayed track array 212 to generate a track analysis outcome 216.

The displayed track array can be shown along with other display modes such as the whole image display, the at least one data graph, and the at least one data sheet. The data from different display modes are linked.

The interactive track analysis views the input image sequence, the selected tracks and the displayed track array in different display modes and performs a single or a plurality of analysis steps including

a) deleting a track from the displayed track array
If the purpose of the analysis is to create a subpopulation of tracks, the unwanted objects can be deleted.

b) assigning a label to a track in the displayed track array
If the purpose of the analysis is to categorize tracks, the tracks can be labeled for each category.

c) entering annotation to a track in the displayed track array
If the purpose of the analysis is to comment on the tracks, the tracks can be annotated.

d) editing a track and updating track measurements
If the purpose of the analysis is to confirm track detection and tracking results, the object detection result or segmentation mask can be edited and the tracking matches can be updated to yield accurate track analysis outcome

e) performing manual measurements of a track
If the purpose of the analysis is to flexibly characterize the selected tracks, manual measurements can be performed. In one embodiment of the invention, the measurement is performed for the track at each time point. The measurement types include (i) line: distance between two end points; (ii) region: area and other characterization features of the track region such as mean and standard deviation of region intensity distribution; (iii) angle: angle between two lines. User can draw line, region or angle and the computer will automatically calculate the features from the manual drawing. The drawing can be done using the frame view.

f) creating a subpopulation of tracks
A subpopulation of tracks with the appropriate categorization and measurements can be created as the analysis outcome.

The track analysis outcome 216 could be the outcomes of any of the above analysis steps or their combinations. In one embodiment of the invention, the track analysis outcome 216 is a subpopulation of tracks after deleting unwanted tracks and properly edit and label the desired tracks.

In one embodiment of the invention, the outcomes of any of the above analysis steps or their combinations such as a subpopulation of tracks with correct detection, masks, tracks and/or desired measurements can be further analyzed using at the least one data graph, and the at least one data sheet. Furthermore, the data could be tested using statistical test methods such as T-test, ANOVA test, MANOVA test, Wilcoxon-Mann Whitney test, Chi-square test, Mcnemar's test, Fisher's test, binomial test, Kolmogorov-Smirnov test, etc.

In another embodiment of the invention, a plurality of subpopulation data acquired from a plurality of input image sequences and a plurality of interactive track analyses can be combined and further analyzed using data graph or data sheet. Furthermore, the combined data could be tested using statistical test methods such as T-test, ANOVA test, MANOVA test, Wilcoxon-Mann Whitney test, Chi-square test, Mcnemar's test, Fisher's test, binomial test, Kolmogorov-Smirnov test, etc.

### III. Computerized Object Sequence Array Interactive Object Sequence Analysis

Computerized object sequence array interactive object sequence analysis is applicable to image sequences where the objects do not move much such as the application of measuring calcium oscillation of cells.

### III.1 Input Image Sequence

This is the same as described in section II.1

### III.2 Object Detection

This is the same as described in section 1.2 except that the detection is performed on one frame of the input image sequence 200. The frame can be specified by a user input or is defaulted to the first frame. In addition to measuring the object measurements in I.2.B for a single or a plurality of time frame, the time dependent object features and time independent track features described in section III.2.B can also be calculated.

### III.3. Object Selection

This is the same as described in section I.3.

### III.4. Object Sequence Array Display

This is the same as II.4 track array display except that it displays regions of the selected object at a time frame selected from a group consisting of object detection used frame, first frame, last frame, middle frame, and a user specified frame.

### III.5. Interactive Object Sequence Analysis

This is basically the same as II.5 interactive track analysis. It views the input image sequence, the selected objects and the displayed object region sequence array and performs an analysis step selected from a group consisting

a) deleting an object sequence from the displayed object region sequence array;

b) assigning a label to an object sequence in the displayed object region sequence array;

c) entering annotation to an object sequence in the displayed object region sequence array;

d) editing an object mask and updating object measurements;

e) performing manual measurements of an object sequence; and

f) creating a sub-population of object sequences.

The object sequence analysis outcome 316 could be the outcomes of any of the above analysis steps or their combinations. In one embodiment of the invention, the object sequence analysis outcome 316 is a subpopulation of object sequences after deleting unwanted object sequence and properly edit and label the desired object sequences.

In one embodiment of the invention, the outcomes of any of the above analysis steps or their combinations such as a subpopulation of object sequences with correct detection masks and/or desired measurements can be further analyzed using at the least one object data graph, and the at least one object data sheet. Furthermore, the data could be tested using statistical test methods such as T-test, ANOVA test, MANOVA test, Wilcoxon-Mann Whitney test, Chi-square test, Mcnemar's test, Fisher's test, binomial test, Kolmogorov-Smirnov test, etc.

In another embodiment of the invention, a plurality of subpopulation data acquired from a plurality of input image sequences and a plurality of interactive object sequence analyses can be combined and further analyzed using object data graph or object data sheet. Furthermore, the combined data could be tested using statistical test methods such as T-test, ANOVA test, MANOVA test, Wilcoxon-Mann Whitney test, Chi-square test, Mcnemar's test, Fisher's test, binomial test, Kolmogorov-Smirnov test, etc.

The invention has been described herein in considerable detail in order to comply with the Patent Statutes and to provide those skilled in the art with the information needed to apply the novel principles and to construct and use such specialized components as are required. However, it is to be understood that the inventions can be carried out by specifically different equipment and devices, and that various modifications, both as to the equipment details and operating procedures, can be accomplished without departing from the scope of the invention itself.

What is claimed is:

1. A computerized object region array interactive object analysis method, comprising the steps of:
a) inputting an input image to a computer memory;
b) performing by a computer program an object detection using the input image to generate a plurality of detected objects;
c) performing an object selection using the detected objects to generate a plurality of selected objects;
d) performing by a computer display an object array display using the selected objects to generate a displayed object region array; and
e) performing an interactive object region analysis using the input image, the selected objects and the displayed object region array to generate an object analysis outcome.

2. The method of claim 1, wherein the object detection comprises the steps of:
b1) performing by a computer program an object segmentation using the input image to generate a plurality of segmented objects; and
b2) performing by a computer program an object measurement using the segmented objects to generate the plurality of detected objects.

3. The method of claim 1, wherein the object selection comprises the steps of:
c1) displaying the detected objects on a computer display as displayed objects; and
c2) performing a selection from the displayed objects to generate the plurality of selected objects.

4. The method of claim 1, wherein the displayed object region array displays regions of the selected objects sorted under an order selected from a group consisting of object feature ranking, object indices, and manual arrangement.

5. The method of claim 1, wherein the displayed object region array includes an option selected from a group consisting of (a) indicating an object location within its object region, (b) overlaying an object with its segmentation mask, and (c) showing multi-channel composite color view of an object.

6. The method of claim 1, wherein the interactive object region analysis uses the input image, the selected objects and the displayed object region array and performs an analysis step selected from a group consisting of:
deleting an object from the displayed object region array;
assigning a label to an object in the displayed object region array;
entering annotation to an object in the displayed object region array;
editing an object mask and updating object measurements;
performing manual measurements of an object; and
creating a subpopulation of objects.

7. The method of claim 1, wherein the input image is a 3D image.

8. The method of claim 2, wherein the object segmentation further comprises an interactive update step.

9. The method of claim 3, wherein the displayed objects display the detected objects on the computer display under a display mode selected from a group consisting of a whole image display, at least one object data graph, and at least one object data sheet.

10. The method of claim 9, wherein the whole image display highlights the detected objects with object indicators.

11. The method of claim 9, wherein the at least one object data graph is selected from a group consisting of a feature histogram plot, an object histogram plot, a scatter plot and a stacked scatter plot, radial graph, mesh graph, surface graph, and volumetric graph.

12. The method of claim 9, wherein the whole image display, the at least one object data graph, and the at least one object data sheet are linked in a way such that selecting an object in one display mode also selects the object in other display modes.

13. The method of claim 6, wherein the interactive object region analysis further comprises a statistical test step.

14. The method of claim 13, wherein the statistical test step is applied to a single or a plurality of subpopulation data, wherein the subpopulation data is acquired from a single or a plurality of input images and a single or a plurality of interactive object region analysis steps.

15. A computerized track array interactive track analysis method, comprising the steps of:
a) inputting an input image sequence to a computer memory;
b) performing by a computer program an object tracking using the input image sequence to generate a plurality of detected tracks;
c) performing a track selection using the detected tracks to generate a plurality of selected tracks;
d) performing by a computer display a track array display using the selected tracks to generate a displayed track array; and
e) performing an interactive track analysis using the input image sequence, the selected tracks and the displayed track array to generate a track analysis outcome.

16. The method of claim 15, wherein the object tracking comprises the steps of:
b1) performing by a computer program an object detection and tracking using the input image sequence to generate a plurality of tracked objects; and
b2) performing by a computer program a tracked object measurement using the tracked objects to generate the plurality of detected tracks.

17. The method of claim 15, wherein the track selection comprises the steps of:
c1) displaying the detected tracks on a computer display as displayed tracks; and
c2) performing an selection from the displayed tracks to generate the plurality of selected tracks.

18. The method of claim 15, wherein the displayed track array displays regions of the selected tracks sorted under an order selected from a group consisting of track feature ranking, track indices, and manual arrangement.

19. The method of claim 15, wherein the displayed track array displays regions of the selected tracks at a time frame selected from a group consisting of track middle frame, track first frame, track last frame, and track event frame.

20. The method of claim 15, wherein the displayed track array includes an option selected from a group consisting of (a) indicating an track location within its track region, (b) overlaying a tracked object with its segmentation mask, and (c) showing multi-channel composite color view of a tracked object.

21. The method of claim 15, wherein the displayed track array allows a focused track to be picked for the interactive object region analysis step.

22. The method of claim 15, wherein the interactive track analysis uses the input image sequence, the selected tracks and the displayed track array and performs an analysis step selected from a group consisting of:
deleting a track from the displayed track array;
assigning a label to a track in the displayed track array;
entering annotation to a track in the displayed track array;
editing a track and updating track measurements;
performing manual measurements of a track; and
creating a subpopulation of track.

23. The method of claim 15, wherein the input image sequence is a 3D image sequence.

24. The method of claim 16, wherein the object detection and tracking further comprises an interactive track update step.

25. The method of claim 17, wherein the displayed tracks display the detected tracks on the computer display under a display mode selected from a group consisting of a whole image display, at least one data graph, and at least one data sheet.

26. The method of claim 25, wherein the whole image display highlights the detected tracks with track indicators.

27. The method of claim 25, wherein the at least one data graph is selected from a group consisting of a feature histogram plot, an object histogram plot, a scatter plot, a stacked scatter plot, radial graph, mesh graph, surface graph, volumetric graph, a time trace plot, a directional plot, a linage plot, a kymograph, and a mean-squared displacement time plot.

28. The method of claim 25, wherein the at least one data sheet is selected from a group consisting of sheet of summary statistics, sheet of object measurements per time point, sheet of track measurements, and sheet of lineage measurements.

29. The method of claim 25, wherein the whole image display, the at least one data graph, and the at least one data sheet are linked in a way such that selecting a track object in one display mode also selects the track in other display modes.

30. The method of claim 21, wherein the focused track is displayed with a frame view.

31. The method of claim 21, wherein the focused track is navigated to view tracked object at different time frames using a navigation bar.

32. The method of claim 22, wherein the interactive track analysis further comprises a statistical test step.

33. The method of claim 32, wherein the statistical test step is applied to a single or a plurality of subpopulation data, wherein the subpopulation data is acquired from a single or a plurality of input image sequences and a single or a plurality of interactive track analysis steps.

34. A computerized object sequence array interactive object sequence analysis method, comprising the steps of:
a) inputting an input image sequence to a computer memory;
b) performing by a computer program an object detection on one frame of the input image sequence to generate a plurality of detected objects;
c) performing an object selection using the detected objects to generate a plurality of selected objects;
d) performing by a computer display an object sequence array display using the selected objects to generate a displayed object region sequence array; and
e) performing an interactive object sequence analysis using the input image sequence, the selected objects and the displayed object region sequence array to generate an object sequence analysis outcome.

35. The method of claim 34, wherein the object detection on one frame of the input image sequence comprises the steps of:
b1) performing by a computer program an object segmentation using the one frame of the input image sequence to generate a plurality of segmented objects; and
b2) performing by a computer program an object measurement using the segmented objects to generate the plurality of detected objects.

36. The method of claim 34, wherein the object selection comprises the steps of:
c1) displaying the detected objects on a computer display as displayed objects; and
c2) performing a selection from the displayed objects to generate the plurality of selected objects.

37. The method of claim 34, wherein the displayed object region sequence array displays time sequences of the regions of the selected objects sorted under an order selected from a group consisting of object feature ranking, object indices, and manual arrangement.

38. The method of claim 34, wherein the displayed object region sequence array displays regions of the selected objects at a time frame selected from a group consisting of object detection used frame, first frame, last frame, middle frame, and a user specified frame.

39. The method of claim 34, wherein the displayed object region sequence array includes an option selected from a group consisting of (a) indicating an object location within its object region sequence, (b) overlaying an object with its segmentation mask, and (c) showing multi-channel composite color view of an object.

40. The method of claim 34, wherein the displayed object region sequence array allows a focused object sequence to be picked for the interactive object sequence analysis step.

41. The method of claim 34, wherein the interactive object sequence analysis uses the input image sequence, the selected objects and the displayed object region sequence array and performs an analysis step selected from a group consisting of:
deleting an object sequence from the displayed object region sequence array;
assigning a label to an object sequence in the displayed object region sequence array;
entering annotation to an object sequence in the displayed object region sequence array;
editing an object mask and updating object measurements;
performing manual measurements of an object sequence; and
g) creating a subpopulation of object sequences.

42. The method of claim 34, wherein the input image sequence is a 3D image sequence.

43. The method of claim 35, wherein the object detection on one frame of the input image sequence further comprises an interactive update step.

44. The method of claim 37, wherein the displayed objects display the detected objects on the computer display under a display mode selected from a group consisting of a whole image display, at least one object data graph, and at least one object data sheet.

45. The method of claim 44, wherein the whole image display highlights the detected objects with object indicators.

46. The method of claim 44, wherein the at least one object data graph is selected from a group consisting of a feature histogram plot, an object histogram plot, a scatter plot, a stacked scatter plot, radial graph, mesh graph, surface graph, volumetric graph, a time trace plot, and a kymograph.

47. The method of claim 44, wherein the at least one object data sheet is selected from a group consisting of sheet of summary statistics, and sheet of object measurements per time point.

48. The method of claim 44, wherein the whole image display, the at least one object data graph, and the at least one object data sheet are linked in a way such that selecting an object in one display mode also selects the object in other display modes.

49. The method of claim 40, wherein the focused object sequence is displayed with a frame view.

50. The method of claim 40, wherein the focused object sequence is navigated to view object at different time frames using a navigation bar.

51. The method of claim 41, wherein the interactive object sequence analysis further comprises a statistical test step.

52. The method of claim 51, wherein the statistical test step is applied to a single or a plurality of subpopulation data, wherein the subpopulation data is acquired from a single or a plurality of input image sequences and a single or a plurality of interactive object sequence analysis steps.
